(19) United States
(12) Patent Application Publication
(10) Pub. No.: US 2009/0193905 A1
(43) Pub. Date: Aug. 6, 2009

(54) Pressure Sensor Package Structure

(75) Inventors: Tetsuya FUKUDA, Niigata-ken (JP); Katsuya KIKUIRI, Niigata-ken (JP); Kiyoshi SATO, Niigata-ken (JP); Mitsuru WATANABE, Niigata-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Alps Electric Company, Ltd., Tokyo (JP)

(21) Appl. No.: 11/911,778

(22) Filed: Oct. 17, 2007

(30) Foreign Application Priority Data
Oct. 17, 2006 (JP) JP 2006-282128

(51) Int. Cl. G01L 9/12

(52) U.S. Cl. 73/724

(57) ABSTRACT

Embodiments of the present disclosure are directed to a package having pressure sensor including a first substrate having a fixed electrode bonded to a second substrate having a movable electrode disposed at a predetermined interval from the fixed electrode, a support substrate with an opening for storing the second substrate, and a resin layer for fixing the pressure sensor and the support substrate. The pressure sensor may be packaged on the support substrate via the first substrate and a bonding member in a state where the second substrate is fit within the opening. The package for the pressure sensor may be sufficiently thin to be employed for the use on a minimum area.

### BACKGROUND OF THE DISCLOSURE

1. Field of the Disclosure

The present disclosure relates to a package for storing a pressure sensor such as a capacitance type pressure sensor.

2. Description of the Related Art

Recently, a capacitance-type pressure sensor and a piezo-type pressure sensor have been developed to be mounted on various types of substrates. Japanese Unexamined Patent Application Publication No. 9-210824 discloses the structure for packaging the pressure sensor having the fixed electrode and the diaphragm oppositely arranged on a substrate with a solder.

Use of the aforementioned pressure sensor has been considered for various applications, for example, detection of a floating of a head in a hard disk drive. Disposing the pressure sensor on a minimum area requires the thickness of the module including the pressure sensor to be reduced as thin as possible.

An entire thickness of the above-disclosed structure may include the thickness of the bonded portion as well as those of the pressure sensor and the substrate. As a result, the entire thickness may be too large to be used for the aforementioned application.

### SUMMARY OF THE DISCLOSURE

Embodiments of the present disclosure may provide a package for a pressure sensor which may be sufficiently thin to be used for application on a minimum area.

A package for a pressure sensor according to the present disclosure may include a pressure sensor formed by bonding a first substrate with a fixed electrode to a second substrate with a movable electrode disposed at a predetermined interval from the fixed electrode, and a support substrate which has an opening for storing the second substrate and is bonded to the first substrate in a state where the second substrate is fit with the opening.

In the aforementioned structure, the first substrate and the support substrate may be electrically coupled via the bonding member in the state where the second substrate of the pressure sensor is stored in the opening while being directed to the support substrate. An entire thickness of the package may be the sum of those of the support substrate, the first substrate and the bonded portion. This may reduce the entire thickness of the structure by the amount corresponding to the thickness of the second substrate compared with the case where the first substrate of the pressure sensor is packaged on the support substrate while being disposed opposite the support substrate.

In one embodiment, the package for the pressure sensor according to the present disclosure may provide that the first substrate be bonded to the support substrate on an area other than a projection area of the movable electrode.

In another embodiment, the package for the pressure sensor according to the present disclosure may further include a resin layer for fixing the pressure sensor and the support substrate.

According to yet another embodiment of the present disclosure, the package for the pressure sensor may include a pressure sensor formed by bonding a first substrate with a fixed electrode to a second substrate with a movable electrode disposed at a predetermined interval from the fixed electrode, and a support substrate which has an opening for storing the second substrate and is bonded to the first substrate in a state where the second substrate is fit with the opening. The package may be formed to be thin enough to be used for the application on the minimum area.

### BRIEF DESCRIPTION OF THE DRAWINGS

FIG. 1 shows a package for a pressure sensor according to an embodiment of the present disclosure; wherein FIG. 1A is a sectional view, and FIG. 1B is an enlarged view of a portion IB shown in FIG. 1A; and

FIG. 2 shows a pressure sensor in the package according to the present disclosure, wherein FIG. 2A is a plan view, and FIG. 2B is a sectional view taken along line IIB-IIB shown in FIG. 2A.

### DETAILED DESCRIPTION

Embodiments according to the present disclosure will be described in detail referring to the drawings.

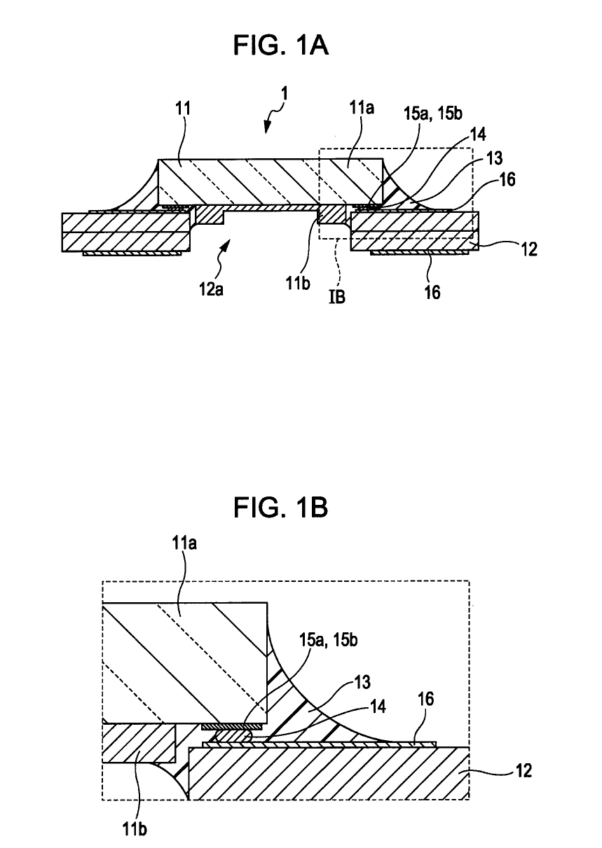

FIG. 1 shows the package for the pressure sensor according to the embodiment of the present disclosure. FIG. 1A is a sectional view, and FIG. 1B is an enlarged view of a portion IB shown in FIG. 1A.

A package 1 for a pressure sensor shown in FIG. 1 may include a pressure sensor 11 formed by bonding a first substrate 11a having a fixed electrode to a second substrate 11b having a movable electrode disposed at a predetermined interval from the fixed electrode, a support substrate 12 having an opening 12a which may be allowed to store the second substrate 11b, and a resin layer 13 for fixing the pressure sensor 11 and the support substrate 12. The pressure sensor 11 may be packaged on the support substrate 12 via the first substrate 11a and a bonding member 14 in the state where the second substrate 11b may fit with the opening 12a.

Referring to FIG. 1B, the bonded portion between the pressure sensor 11 and the support substrate 12 may be formed by electrically coupling an electrode 16 provided on a bonded area of the support substrate 12 with electrodes 15a, 15b disposed on the first substrate of the pressure sensor 11 via the bonding member 14.

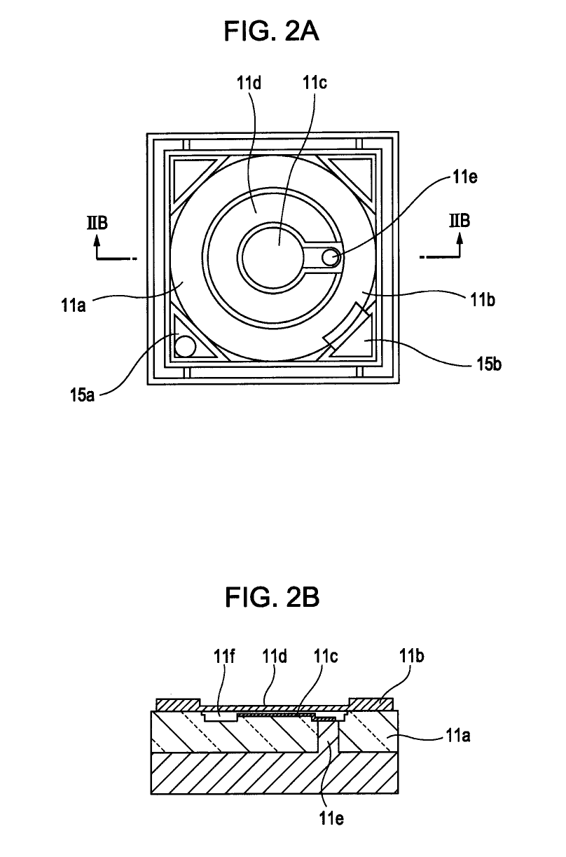

The pressure sensor 11 may have the structure as shown in FIGS. 2A and 2B. A glass substrate may be employed as the first substrate 11a, as shown in the drawing. A recess portion as a cavity 11f may be formed in the primary surface at one side of the first substrate 11a. A convex portion may be formed on the aforementioned area, on which the fixed electrode 11c may be formed. The second substrate 11b having a diaphragm 11d as a movable electrode disposed at a predetermined interval from the fixed electrode 11c may be bonded to the primary surface at the aforementioned side of the first substrate 11a. A silicon substrate may be employed as the second substrate 11b.

A third substrate having a conductive member 11e may be bonded to the primary surface at the other side of the first substrate 11a. The conductive member 11e may be exposed to the primary surface at the side of the first substrate 11a, with which the fixed electrode 11c may be electrically coupled.

Assuming that the first substrate 11a is formed of the glass substrate, and the second substrate 11b is formed of the silicon substrate, in one embodiment, for example, the first and the second substrates may be the positive electrode bonded for improving the air tightness within the cavity 11f. Assuming that the first substrate 11a is formed of the glass substrate and the third substrate is formed of the silicon substrate, the glass substrate is placed on the silicon substrate having a protrusion as the conductive member, and the silicon substrate and the glass substrate are heated to push the silicon substrate onto the glass substrate, the conductive member may be pushed to the glass substrate so as to be bonded for embedding the conductive member in the glass substrate.

Referring to FIG. 2A, the electrodes 15a and 15b may be formed on the first substrate 11a so as to be electrically coupled with the support substrate 12. The electrode 15a may be used for the fixed electrode, and the electrode 15b may be used for the diaphragm. An area on which those electrodes 15a and 15b are formed may be the area other than a projection area of the diaphragm 11d. In FIG. 2, the first substrate 11a may have a substantially rectangular shape, and the diaphragm 11d may have a substantially circular shape. The areas on which the electrodes 15a and 15b are formed may have substantially triangular shapes at the respective corners as shown in FIG. 2A. This may efficiently reduce the entire thickness of the package having the pressure sensor 1 packaged on the support substrate 2. The area for forming the electrode may not limited to the one as shown in FIG. 2A, but may be set to the arbitrary area so long as it is other than the projection area of the diaphragm 11d.

The support substrate 12 may include an opening 12a which is large enough to accommodate the second substrate 11b of the pressure sensor 11 to be fit therewith. The size of the opening 12a may be determined in accordance with the size of the second substrate 11b of the pressure sensor 11. In this way, as the support substrate 12 may include the opening 12a with which the second substrate 11b of the pressure sensor 11 is fit, the positioning for packaging the pressure sensor 11 on the support substrate 12 may be easily performed. The opening 12a may serve as the passage (air vent) through which the air caught during formation of the resin layer 13 is discharged.

The package area of the support substrate 12 (the primary surface at least at one side) may have an electrode 16 formed thereon. The pressure sensor 11 may be packaged on the electrode 16. An aluminum substrate, glass-epoxy substrate, a flexible print wiring board, a glass-silicon composite substrate, and other similar substrates/materials may be employed as the support substrate 12.

For example, a UV cure resin material may be employed as the material for forming the resin layer 13. The aforementioned resin layer 13 may make it possible to improve the bonding strength of the bonded area between the pressure sensor 11 and the support substrate 12.

The pressure sensor 11 may be packaged on the electrode 16 of the support substrate 12 via the bonding member 14. The pressure sensor 11 may be packaged such that the diaphragm 11d is directed opposite the support substrate 12 (the diaphragm 11d is at the lower side and the first substrate 11a is at the upper side), and the second substrate 11b may be fit with the opening 12a. In the aforementioned state, the first substrate 11a of the pressure sensor 11 may be electrically coupled with the support substrate 12 via the bonding member 14. The bump formed of a metal, for example, solder and gold, and all the members used for the generally employed surface mount process such as the conductive adhesive agent may be employed as the bonding member 14 for packaging the pressure sensor 11 on the support substrate 12.

The aforementioned package for the pressure sensor may be structured to electrically couple the first substrate 11a and the support substrate 12 via the bonding member 14 in the state where the second substrate of the pressure sensor 11 is stored in the opening 12a while being directed to the support substrate 12. The entire thickness of the package 1 may be a value derived from summing those of the support substrate 12, the first substrate 11a and the bonded portion. This may reduce thickness by an amount corresponding to the thickness of the second substrate 11b as compared with the case where the first substrate 11a of the pressure sensor 11 is packaged on the support substrate 12 while being directed to the support substrate 12.

As the support substrate 12 of the package 1 may have the opening 12a with which the second substrate 11b of the pressure sensor 11 is fit, the positioning for packaging the pressure sensor 11 on the support substrate 12 may be easily performed.

The use of the above-structured package may be especially effective for the capacity-type pressure sensor produced through MEMS (Micro Electro Mechanical Systems) with the gap of several μms or less than 1 μm which may be employed on the minimum area.

It should be appreciated that embodiments of the present disclosure may not be limited to the aforementioned embodiments, but may be modified into various forms. Values or materials, and configurations of the components which have been explained in the aforementioned embodiment may also not be limited. In addition, the adhesion process described above with respect to an embodiment of the present disclosure may be performed under various generally-employed conditions. Processes discussed with respect to the aforementioned embodiments are not limited, and may be allowed to change the order of the respective steps of the process. Embodiments of the present disclosure may also be modified so long as it does not deviate from the scope of the present disclosure.

The present disclosure may be applied, for exemplary purposes, to the package for the pressure sensor used for detecting floating of a head in a hard disk drive.

1. A pressure sensor package comprising:
a pressure sensor having a first substrate bonded to a second substrate, wherein the first substrate has a fixed electrode and the second substrate has a movable electrode disposed at a predetermined interval from the fixed electrode; and
a support substrate having an opening, wherein the support substrate is bonded to the first substrate such that the second substrate fits within the opening.

2. The pressure sensor package according to claim 1, wherein the first substrate is bonded to the support substrate on an area other than a projection area of the movable electrode.

3. The pressure sensor package according to claim 1, further comprising a resin layer to affix the pressure sensor and the support substrate.

4. The pressure sensor package according to claim 3, wherein the resin layer is formed from a UV cure resin material.

5. The pressure sensor package according to claim 1, wherein the first substrate is a glass substrate and the second substrate is a silicon substrate.

6. The pressure sensor package according to claim 1, wherein the support substrate is made of at least one of aluminum, glass-epoxy, glass-silicon, and flexible print wiring board.

7. The pressure sensor package according to claim 1, wherein the pressure sensor further comprises a third substrate bonded to the first substrate at a surface opposite to the surface bonded to the second substrate, wherein the third substrate has a conductive member.

8. The pressure sensor package according to claim 7, wherein the first substrate is a glass substrate and the third substrate is a silicon substrate.

9. The pressure sensor package according to claim 1, wherein the first substrate has a substantially rectangular shape.

10. The pressure sensor package according to claim 1, wherein the movable electrode has a substantially circular shape.

11. The pressure sensor package according to claim 1, wherein an area where the fixed electrode and the movable electrode is formed has a substantially triangular shape.

12. The pressure sensor package according to claim 1, wherein the package has a thickness substantially equal to the sum thickness of the first substrate, the support substrate, and a bonding portion between the first substrate and the support substrate.

13. A method of making a pressure sensor package, the method comprising:
bonding a first substrate to a second substrate, wherein the first substrate has a fixed electrode and the second substrate has a movable electrode disposed at a predetermined interval from the fixed electrode; and
bonding a support substrate having an opening to the first substrate such that the second substrate fits within the opening.

14. The method according to claim 13, wherein the first substrate is bonded to the support substrate on an area other than a projection area of the movable electrode.

15. The method according to claim 13, further comprising affixing the pressure sensor and the support substrate with a resin, wherein the resin layer is formed from a UV cure resin material.

16. The method according to claim 13, further comprising bonding a third substrate to the first substrate at a surface opposite the surface bonded to the second substrate, wherein the third substrate has a conductive member.

17. The method according to claim 16, wherein further comprising fitting the conductive member within a recess in the first substrate so that the conductive member is exposed on the side of the first substrate bonded to the second substrate.
